(19) United States
(12) Patent Application Publication
(10) Pub. No.: US 2018/0335877 A1
(43) Pub. Date: Nov. 22, 2018

(54) ARRAY SUBSTRATE AND SELF CAPACITANCE IN CELL TOUCH DISPLAY PANEL

(71) Applicant: WUHAN CHINA STAR OPTOELECTRONICS TECHNOLOGY CO., LTD., Wuhan, Hubei (CN)

(72) Inventors: Zhou ZHANG, Shenzhen, Guangdong (CN); Pan XU, Shenzhen, Guangdong (CN); Changwen MA, Shenzhen, Guangdong (CN); Yucheng TSAI, Shenzhen, Guangdong (CN)

(73) Assignee: Wuhan China Star Optoelectronics Technology Co., Ltd., Wuhan, Hubei (CN)

(21) Appl. No.: 15/543,994

(22) PCT Filed: Mar. 22, 2017
(86) PCT No.: PCT/CN2017/077762

§ 371 Date: Jul. 15, 2017

(30) Foreign Application Priority Data
Mar. 10, 2017 (CN) 201710142299.8

(51) Int. Cl. G06F 3/041; G06F 3/044

(52) U.S. Cl. CPC G06F 3/0412; G06F 3/0416; G06F 3/044

(57) ABSTRACT

Disclosed is an array substrate, comprising a substrate; a driving unit; a common electrode layer, and the common electrode layer comprising a plurality of touch electrodes, which are separately arranged, and the plurality of touch electrodes receiving a touch signal and a first common voltage in time division; a plurality of wires, being provided on the substrate and extending along a first direction, and two ends of each of the wires being electrically connected to one of the touch electrodes and the driving unit, respectively; at least one compensation line, which is separately arranged from the wires, and the compensation line extending in a direction opposite to the first direction, and the compensation line being overlapped with at least one of the touch electrodes, and the compensation line receiving a second common voltage as the one of the touch electrodes receives the first common voltage.

### CROSS REFERENCE

This application claims the priority of Chinese Patent Application No. 201710142299.8, entitled “Array substrate and self capacitance in cell touch display panel”, filed on Mar. 10, 2017, the disclosure of which is incorporated herein by reference in its entirety.

### FIELD OF THE INVENTION

The present invention relates to a touch display technology field, and more particularly to an array substrate and a self capacitance in cell touch display panel.

### BACKGROUND OF THE INVENTION

Please refer to FIG. 1 and FIG. 2, the self capacitance in cell touch display panel according to prior art comprises an array substrate, and the array substrate comprises a substrate 110, a driving unit 120, a common electrode layer and a plurality of wires 140. The driving unit 120, the common electrode layer and the plurality of wires 140 are located on the substrate 110. The driving unit 220 outputs a touch signal and a first common voltage. The common electrode layer comprises a plurality of touch sets, and the touch sets are elongated and comprises a plurality of touch electrodes 130, which are spaced apart and extend in a direction from top to bottom. The touch electrode 130 has a touch control function and also is used to be a common electrode as a pixel capacitor. The plurality of touch electrodes 130 receives the touch signal and the common voltage in time division. When the touch electrodes 130 are used for touch control, the touch electrodes 130 receive the touch signal, and when the touch electrodes 130 are used for the common electrodes of the pixel capacitors, the touch electrodes 130 receive the common voltages. The wires 140 are electrically connected to the touch electrodes 130 and the driving unit 120. There are two alignments of the existing wires 140 on the array substrate.

One alignment is shown in FIG. 1. The wires 140 have the same length and extend from one end of all touch sets remote from the driving unit 120 to the drive unit 120 to be electrically connected thereto. Namely, each wire 140 runs through the entire set of touch electrodes 130, and the numbers of touch electrodes 130 across by all of the wires 140 are the same. Such way is named as the running through type. In such alignment of the wires 140, because the wires 140 are longer, it leads to the larger RC loading as the touch electrodes 130 are used for the touch control function. Thus, the touch signal is distorted in transmission, which results in poor touch property. However, the touch electrodes 130 also serve as common electrodes in this way and the wires 140 extend from one end of each touch set remote from the driving unit 120 to be electrically connected with the driving unit 120, and then the common voltages on the touch electrodes 130 are uniform and the display effect of the screen is better.

Please refer to FIG. 2 for the other alignment. The wires 140 electrically connected to the touch electrodes 130 in each set are not equal in length. The specific positions of the wires 140 are gradually reduced from left to right. Namely, the numbers of the touch electrodes 130 ran through by the wires 140 are gradually reduced from left to right, which is referred to as a non running through type. Such alignment of wires 140, wires 140 electrically connected to the touch electrodes 130 in each set are gradually reduced, it leads to the smaller RC loading as the touch electrodes 130 are used for the touch control function. Thus, the touch signal is less distorted in transmission, which results in the better touch property. However, since the touch electrodes 130 also serve as common electrodes and the wires 140 are not equal in length, and then the uniformity of the common voltages on the touch electrodes 130 is worse and the display effect of the screen is poorer.

### SUMMARY OF THE INVENTION

The technical issue that the embodiment of the present invention solves is to provide an array substrate and a self capacitance in cell touch display panel. The present invention has a good touch property and a good display effect at the same time.

For solving the aforesaid technical issue, the present invention first provides an array substrate, comprising:
a substrate;
a driving unit, being provided on the substrate and outputting a touch signal and a first common voltage;
a common electrode layer, being provided on the substrate, and the common electrode layer comprising a plurality of touch electrodes, which are separately arranged, and the plurality of touch electrodes receiving the touch signal and the first common voltage in time division;
a plurality of wires, being provided on the substrate and extending along a first direction, and two ends of each of the wires being electrically connected to one of the touch electrodes and the driving unit, respectively;
at least one compensation line, which is separately arranged from the wires, and the compensation line extending in a direction opposite to the first direction, and the compensation line being overlapped with at least one of the touch electrodes, and the compensation line receiving a second common voltage as the one of the touch electrodes receives the first common voltage, and the first common voltage being equal to the second common voltage.

A number of the compensation lines is plural, and the compensation lines are separately arranged corresponding to the wires, respectively.

The number of the compensation lines is the same as a number of the wires.

Overlapped areas of the compensation lines with the touch electrodes are partially the same and partially different, and a length of the compensation line is negatively correlated with a length of a corresponding wire, and one end of the compensation line correspondingly close to one end of the wire and the one end of the wire correspondingly close to the one end of the compensation line are located above or below the same touch electrode; or all of the overlapped areas of the compensation lines with the touch electrodes are equal; or all of the overlapped areas of the compensation lines with the touch electrodes are different.

The compensation line is located on an extension line of a wire corresponding thereto.

The array substrate further comprises at least one suspension line, and the suspension line extending from one end of the wire electrically connected to the touch electrode in the direction opposite to the first direction, and the suspension line is electrically connected to the wire, and the suspension line is insulated from the compensation line, and the suspension line is located between a corresponding wire and a corresponding compensation line, or the corresponding wire of the suspension line has no compensation line corresponding thereto.

The array substrate further comprises a control switch, wherein a control end of the control switch receives a control voltage to control on and off thereof, and an input end of the control switch receives the second common voltage, and an output end of the control switch is electrically connected to all of the compensation lines.

M sets of touch electrodes are formed on the substrate, and each set comprises N of the touch electrodes, and the N of the touch electrodes in each set are arranged in the first direction, and a number of the wires is M*N, and each of the wires is electrically connected to one of the touch electrodes, and the first direction is a direction from top to bottom or from bottom to top, and lengths of the wires electrically connected to the touch electrodes in the same set are arranged in a descending order or in an ascending order, wherein N, M≥2.

A layer where the wires are located on the substrate is different from a layer where the touch electrode are on the substrate, and an insulation layer is provided between the wires and the touch electrodes, and the compensation lines and the wires are in the same layer on the substrate.

Second, the embodiment of the present invention provides a self capacitance in cell touch display panel, comprising an array substrate, and the array substrate comprises:
a substrate;
a driving unit, being provided on the substrate and outputting a touch signal and a first common voltage;
a common electrode layer, being provided on the substrate, and the common electrode layer comprising a plurality of touch electrodes, which are separately arranged, and the plurality of touch electrodes receiving the touch signal and the first common voltage in time division;
a plurality of wires, being provided on the substrate and extending along a first direction, and two ends of each of the wires being electrically connected to one of the touch electrodes and the driving unit, respectively;
at least one compensation line, which is separately arranged from the wires, and the compensation line extending in a direction opposite to the first direction, and the compensation line being overlapped with at least one of the touch electrodes, and the compensation line receiving a second common voltage as the one of the touch electrodes receives the first common voltage, and the first common voltage being equal to the second common voltage.

A number of the compensation lines is plural, and the compensation lines are separately arranged corresponding to the wires, respectively.

The number of the compensation lines is the same as a number of the wires.

Overlapped areas of the compensation lines with the touch electrodes are partially the same and partially different, and a length of the compensation line is negatively correlated with a length of a corresponding wire, and one end of the compensation line correspondingly close to one end of the wire and the one end of the wire correspondingly close to the one end of the compensation line are located above or below the same touch electrode; or all of the overlapped areas of the compensation lines with the touch electrodes are equal; or all of the overlapped areas of the compensation lines with the touch electrodes are different.

The compensation line is located on an extension line of a wire corresponding thereto.

The array substrate further comprises at least one suspension line, and the suspension line extending from one end of the wire electrically connected to the touch electrode in the direction opposite to the first direction, and the suspension line is electrically connected to the wire, and the suspension line is insulated from the compensation line, and the suspension line is located between a corresponding wire and a corresponding compensation line, or the corresponding wire of the suspension line has no compensation line corresponding thereto.

The array substrate further comprises a control switch, wherein a control end of the control switch receives a control voltage to control on and off thereof, and an input end of the control switch receives the second common voltage, and an output end of the control switch is electrically connected to all of the compensation lines.

M sets of touch electrodes are formed on the substrate, and each set comprises N of the touch electrodes, and the N of the touch electrodes in each set are arranged in the first direction, and a number of the wires is M*N, and each of the wires is electrically connected to one of the touch electrodes, and the first direction is a direction from top to bottom or from bottom to top, and lengths of the wires electrically connected to the touch electrodes in the same set are arranged in a descending order or in an ascending order, wherein N, M≥2.

A layer where the wires are located on the substrate is different from a layer where the touch electrode are on the substrate, and an insulation layer is provided between the wires and the touch electrodes, and the compensation lines and the wires are in the same layer on the substrate.

With implementing the embodiments of the present invention, the benefits are: since two ends of each of the wires are electrically connected to one of the touch electrodes and the driving unit, respectively. Therefore, the arrangement of the wires is not the running through type. When the touch electrode acts as a touch, the RC loading is small so that the touch signal is less distorted in transmission and has better touch characteristics; besides, the compensation line overlaps at least one touch electrode, and the compensation line receives a second common voltage as the touch electrode receives the first common voltage, and the first common voltage is equal to the second common voltage. Accordingly, the second common voltage transmitted by the compensation line may enhance the first common voltage on the touch electrode which is overlapped therewith for improving the problem that the first common voltage uniformity of the touch electrodes is poor to further improve the display effect of the screen.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a diagram of an array substrate according to prior art;

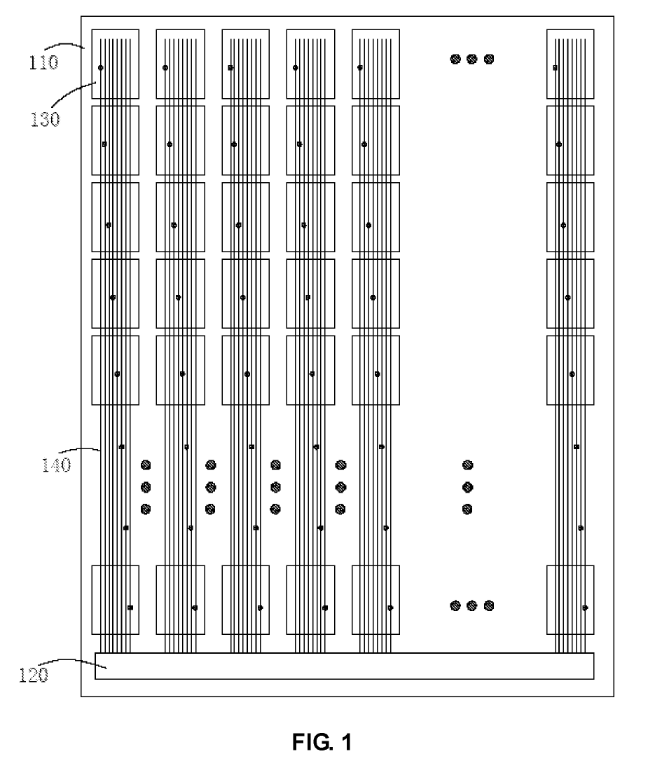

FIG. 2 is a diagram of another array substrate according to prior art;

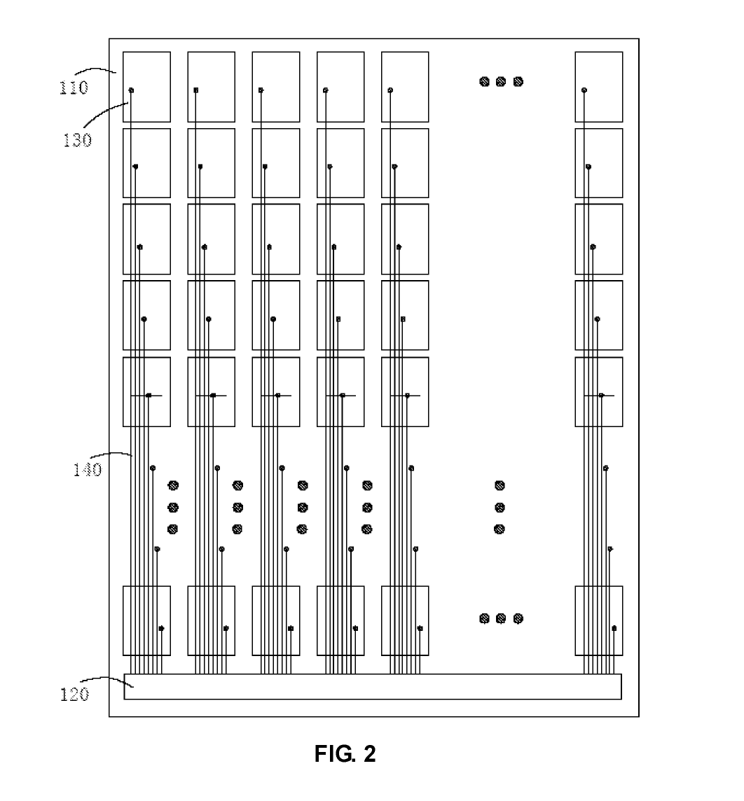

FIG. 3 is a diagram of an array substrate according to the first embodiment of the present invention;

FIG. 4 is an enlarged view diagram of the oval region of FIG. 3;

FIG. 5 is a diagram of an array substrate according to another embodiment of the present invention;

FIG. 6 is a diagram of an array substrate according to the second embodiment of the present invention;

FIG. 7 is an enlarged view diagram of the oval region of FIG. 6.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

Furthermore, the terms “including” and “having” and their any deformations are intended to cover non-exclusive inclusion. For example, a process, a method, a system, a product or a device comprising a series of steps or units which is not limited to the steps or units already listed, but optionally further comprises steps or units which are not listed, or optionally further comprises other steps or units which are inherent in these the process, the method, the product or the device. The terminologies “first”, “second” and “third” are used for distinguishing different objects but not for describing the specific sequence.

### The First Embodiment

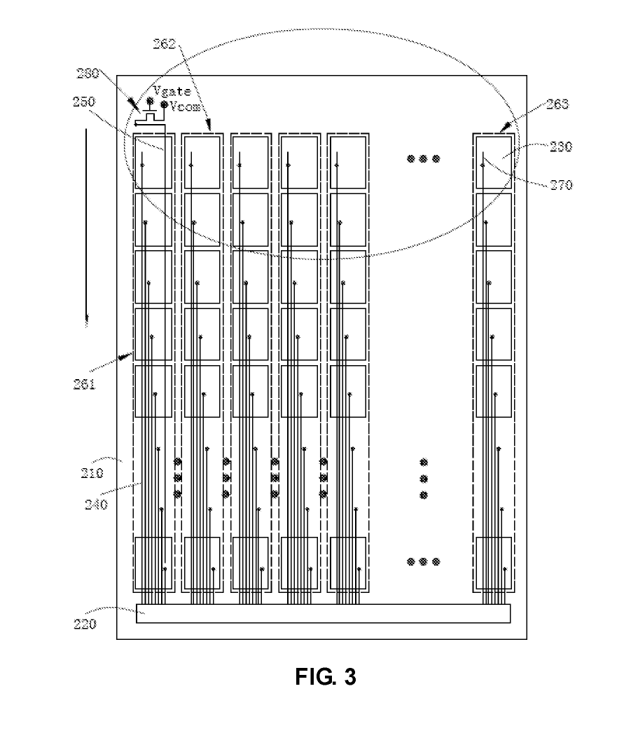

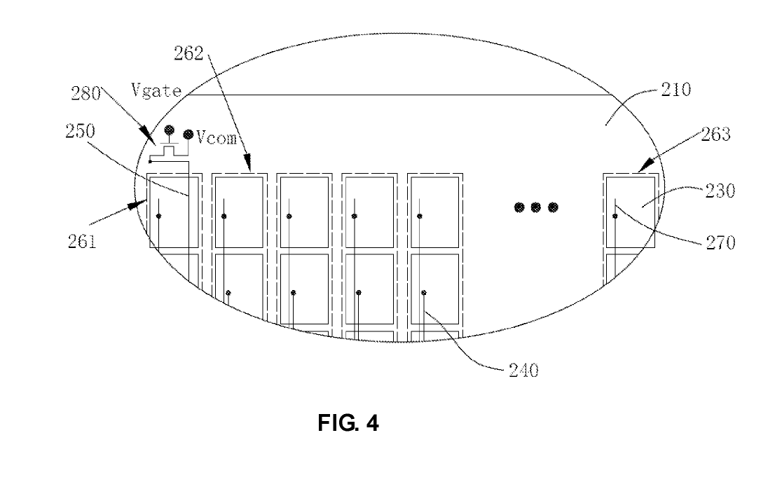

The self capacitance in cell touch display panel provided by the present invention comprises an array substrate. Please refer to FIG. 3 and FIG. 4. The array substrate comprises a substrate 210, a driving unit 220, a common electrode layer, a plurality of wires 240 and at least one compensation line 250.

The substrate 210 may be a rigid substrate 210, such as a glass substrate 210, or a flexible substrate 210, such as a polyimide plastic substrate 210.

The driving unit 220 is located on the substrate 210, for example, on the lower side or the upper side of the substrate 210. The driving unit 220 outputs a touch signal and a first common voltage. The touch signal is outputted to touch electrodes 230 which are mentioned later for detecting whether a touch control occurs. The first common voltage is provided to the touch electrodes 230 so that the touch electrodes 230 serve as common electrodes for pixel capacitors.

The common electrode layer is provided on the substrate 210, and the common electrode layer comprises a plurality of touch electrodes 230, which are separately arranged. The plurality of touch electrodes 230 are electrically insulated from one another. In this embodiment, touch electrode 230 has a rectangular shape. The touch electrode 230 has a function of detecting a touch control, i.e., as a touch electrode 230, and has a display function, i.e., a common electrode of a pixel capacitor. Namely, the touch electrodes 230 in this embodiment have two functions, which is conducive to being light and thin for the touch display panel and can reduce the cost. The plurality of touch electrodes 230 receive the touch signal and the first common voltage in time division. For instance, the touch electrodes 230 receive the touch signal in a first time period, and the touch electrode 230 receive the first common voltage in a second time period. The first time period and second time period are different. In this embodiment, the first time period and the second time are included in a frame of the self capacitance in cell touch display panel. In this embodiment, the touch signal and the first common voltage received on the touch electrode 230 are outputted by the driving unit 220.

The plurality of wires 240 are provided on the substrate 210 and extend along a first direction (arrow direction in the figure). In this embodiment, the first direction is a direction from top to bottom. Namely, the wires 240 extend downward. However, the present invention is not limited thereto, and in other embodiments of the present invention, the first direction may be a direction from bottom to top. Two ends of each of the wires 240 are electrically connected to the touch electrodes 230 and the driving unit 220, respectively. Then, the lengths of the corresponding wires 240 are different depending on the different distances between the touch electrodes 230 and the driving unit 220. Namely, overlapped areas of the wires 240 having different lengths with the touch electrodes 230 are different. The wires 240 transmit the signal outputted from the driving unit 220.

In this embodiment, for alleviating the problem that the first common voltage uniformity of the touch electrodes 230 is poor, at least one compensation line is located on the substrate and is separately arranged from the wires. Namely, the wires 240 are electrically insulated from the compensation lines 250, and the touch signal or the first common voltage signal transmitted on the wires 240 will not be transmitted to the compensation lines 250. In this embodiment, a number of the compensation lines 250 is one. Certainly, in other embodiments of the present invention, the number of the compensation lines may be plural, such as two, three, four, ten and twenty. In this embodiment, the compensation line 250 extends in a direction opposite to the first direction. Namely, the compensation line 250 extends from bottom to top. The compensation line 250 is overlapped with the at least one touch electrode 230. In this embodiment, the compensation line 250 overlaps with the plurality of touch electrodes 230. Certainly, in other embodiments of the present invention, the compensation line may be partially overlapped with one touch electrode, overlapped with one touch electrode, overlapped with two touch electrodes or overlapped with three touch electrodes. Here, the overlap of the compensation line 250 with one touch electrode 230 means that the compensation line 250 runs through the touch electrode 230 or does not run through the touch electrode 230. The compensation line 250 receives a second common voltage as the touch electrode 230 receives the first common voltage. The second common voltage is equal to the first common voltage, such as both 5V. The second common voltage may be derived from the driving unit 220 or may not be derived from the driving unit 220.

In this embodiment, since two ends of each of the wires 240 are electrically connected to one of the touch electrodes 230 and the driving unit 220, respectively. Therefore, the arrangement of the wires 240 is not the running through type. When the touch electrode 230 acts as a touch, the RC loading is small so that the touch signal is less distorted in transmission and has better touch characteristics; besides, the compensation line 250 overlaps at least one touch electrode 230, and the compensation line 250 receives a second common voltage as the touch electrode 230 receives the first common voltage, and the first common voltage is equal to the second common voltage. Accordingly, the second common voltage transmitted by the compensation line 250 may enhance the first common voltage on the touch electrode 230 which is overlapped therewith for improving the problem that the first common voltage uniformity of the touch electrodes 230 is poor to further improve the display effect of the screen.

In this embodiment, the compensation line 250 is provided corresponding to one of the wires 240. Specifically, it is provided corresponding to the shortest wire 240. The compensation line 250 is right provided for the shortest wire 240, i.e. the compensation line 250 is located on an extension line of the shortest wire 240. Certainly, in other embodiment of the present invention, the compensation line also may be slightly offset from the wire. Namely, the compensation line may be located corresponding to one side of the wire.

In this embodiment, the array substrate further comprises a control switch 280, wherein a control end of the control switch 280 receives a control voltage to control on and off thereof, and an input end of the control switch 280 receives the second common voltage, and an output end of the control switch 280 is electrically connected to all of the compensation lines 250. In this embodiment, the control switch 280 is a thin film transistor, and a number of the thin film transistor is one, and the number of the compensation line 250 is one. In other embodiments of the present invention, the control switch may be a MOS transistor.

In this embodiment, M sets of touch electrodes 230 are formed on the substrate 210, and each set comprises N of the touch electrodes 230, i.e. M*N of the touch electrodes 230 are provided, wherein N, M≥2. For instance, M is a positive integer, such as 2, 3, 6, 8, 10 or 20, and N is a positive integer, such as 2, 3, 6, 8, 10 or 20. N of the touch electrodes 230 in each set are arranged in the first direction. In this embodiment, the first direction is a direction from top to bottom, and N of the touch electrodes 230 in each set are formed in a column. A number of the wires 240 is M*N. Each wire 240 is electrically connected to one touch electrode 230. Namely, the touch electrodes 230 have one-to-one relationship with the wires 240. In this embodiment, the driving unit 220 is located on the lower side of the touch electrodes 230. One end of the wire 240 is electrically connected to the touch electrode 230 corresponding thereto. Thus, the lengths of the wires 240 electrically connected to the touch electrodes 230 in the same set are arranged in a descending order or in an ascending order. In this embodiment, the lengths of the wires 240 electrically connected to the touch electrodes 230 in the same set are arranged in a descending order. Please continue referring to FIG. 3. In the first set (column) of touch electrodes 230, the wire 240 (the first wire 240 from the left side) electrically connected to the first touch electrode 230 is the longest, and the wire 240 (the second wire 240 from the left side) electrically connected to the second touch electrode 230 is the second long, and the wire 240 (the third lead wire 240 from the left side) electrically connected to the third touch electrode 230 keeps to be shortened, . . . , and the wire 240 (the Nth wire 240 from the left side) electrically connected to the Nth touch electrode 230 is the shortest. The length order of the lead wires 240 in the other sets is the same as the length order of the first set. Namely, the number of the longest wires 240, the number of the second long wires 240, . . . , the number of the shortest wires 240 are M, respectively. In this embodiment, the first direction is a direction from top to bottom but the present invention is not limited thereto. In other embodiments of the present invention, the first direction may be a direction from bottom to top, or the first direction can be a direction from left to right or a direction from right to left.

In this embodiment, a layer where the wires 240 are located on the substrate 210 is different from a layer where the touch electrodes 230 are located on the substrate 210. For instance, the wires 240 are located above or below the touch electrodes 230, and an insulation layer is provided between the wires 240 and the touch electrodes 230, and the electrical connection between the lead 240 and the touch electrode 230 is achieved by a through hole penetrating the insulation layer. In this embodiment, the compensation lines 250 and the wires 240 are located in the same layer on the substrate 210. Certainly, in other embodiments of the present invention, the compensation lines 250 and the wires 240 may also be located in different layers on the substrate 210. For instance, the wires 240 are located below the touch electrodes 230, and the compensation lines 250 are located above the touch electrodes 230.

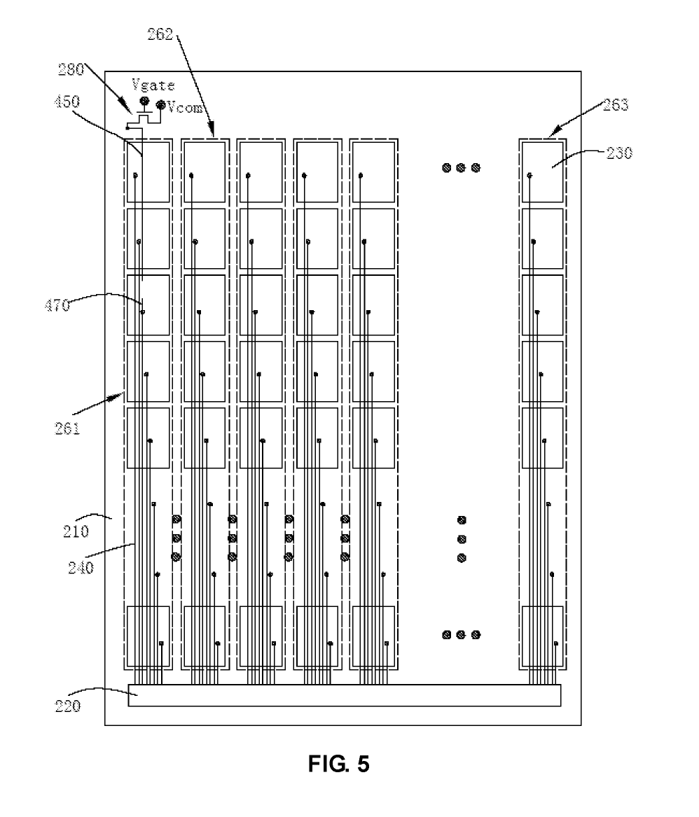

In this embodiment, continue referring to FIG. 3, the array substrate further comprises at least one suspension line 270, and the suspension line 270 extending from one end of the wire 240 electrically connected to the touch electrode 230 in the direction opposite to the first direction, i.e. the suspension line 270 extends upwards, and the suspension line 270 is electrically connected to the wire 240 and the suspension line 270 may be integrally formed with the corresponding wire 240, and the suspension line 270 is insulated from the compensation line 250, i.e. no electrical connection is provided between the two. In this embodiment, the suspension line 270 is not electrically connected to the wire 240 opposite to the compensation line 250. Namely, the corresponding wire 240 of the suspension line 270 has no compensation line 250 corresponding to the wire 240, i.e. the corresponding wire 240 electrically connected to the suspension line 270 has no compensation line 250 corresponding to the wire 240. Specifically, in the first set of touch electrodes 261, the first wire 240 extends a suspension line 270, and the first wire 240 has no compensation line 250 corresponding thereto, and one of the compensation lines 250 is opposite to the Nth wire 240. However, the present invention is not limited thereto, and in other embodiments of the present invention, referring to FIG. 5, the suspension line 470 can be electrically connected to the wire 240 opposite to the compensation line 450. Then, the suspension line 470 is located between a corresponding compensation line 450 and a corresponding wire 240. In this embodiment, the length of the suspension line 270 is shorter, such as 1 micrometer to 1000 micrometers, and 1 micrometer, 10 micrometers, 100 micrometers or 1000 micrometers can be illustrated. The suspension line 270 cannot be too long, otherwise the more number of suspension lines 270 will cause the distortion of the touch signal. In this embodiment, the arrangement of the suspension lines 270 may also be used to make the first common voltages on the touch electrodes 230 more uniform. The number of the suspension lines 270 can be plural or can be one. The layer where the suspension lines 270 are located is the same layer where the wires 240 are located.

In this embodiment, the opposition of one compensation line 250 and one wire 240 means that the lower end of the compensation line 250 is closest to the upper end of the wire 240. For instance in FIG. 3, the compensation line 250 is arranged opposite to the Nth wire 240.

In this embodiment, the number of the compensation lines 250 is one, and then the second common voltage on the compensation line 250 has a limited improvement in the display effect of the screen. The second embodiment will be described below to further improve the display effect of the screen.

### The Second Embodiment

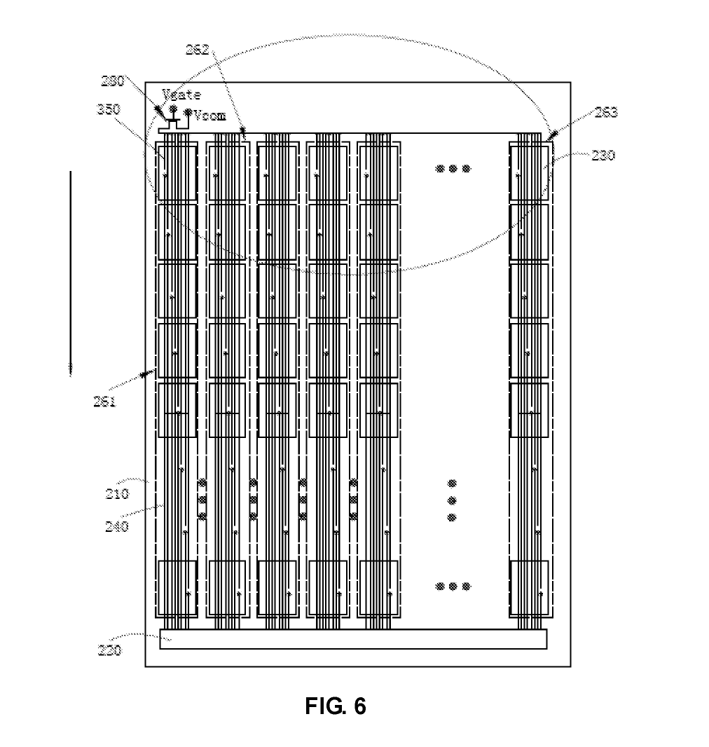

FIG. 6 is an array substrate according to the second embodiment of the present invention. The structure of FIG. 6 is similar to the structure of FIG. 3. Therefore, the same reference numerals denote the same elements, and the main difference between this embodiment and the first embodiment is the number of the compensation lines 350.

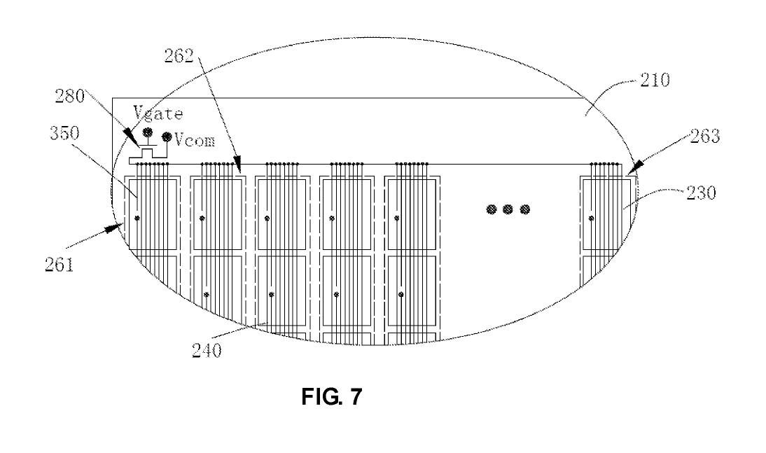

Please refer to FIG. 6 and FIG. 7. In this embodiment, a number of the compensation lines 350 is plural, and the compensation lines 350 are separately arranged corresponding to the wires 240, respectively. In this embodiment, the number of the compensation lines 350 is the same as a number of the wires 240. Namely, the number of the compensation lines 350 is also N*M, and the N*M compensation lines 350 are arranged corresponding to the N*M wires 240 one by one. However, the present invention is not limited thereto, and in other embodiments of the present invention, the number of the compensation lines may be less than the number of the wires, or may be larger than the number of the wires.

In this embodiment, the compensation line 250 is right provided for one of the wires 240, i.e. the compensation line 250 is located on an extension line the one of the wires 240. A length of the compensation line 350 is negatively correlated with a length of a corresponding wire 240. The lengths of the wires 240 electrically connected to the touch electrodes 230 in the same set are arranged in a descending order, and thus, in this embodiment, the compensation lines 350 in the same set are arranged in a descending order. Then, the overlapped areas of the compensation lines 350 with the touch electrodes 230 in the same set are different. In this embodiment, the compensation line 350 is in a complementary relationship with the wire 240. Any wire 240 is equal or approximately equal to a sum of the lengths of the compensation lines 350 corresponding thereto. One end of the compensation line 350 correspondingly close to one end of the wire 240 and the one end of the wire 240 correspondingly close to the one end of the compensation line 350 are located above or below the same touch electrode 230. In this embodiment, the arrangements of the compensation lines 350 in any two sets are the same or similar. Because there are M sets, the number of the compensation lines 350 of any length is M. For instance, the length of the first compensation line 350 (the first compensation line 350 from the left side) corresponding to the second set to the Mth set is the same as the length of the first compensation line 350 in the first set. Namely, the overlapped areas of the touch electrodes 230 are the same; the length of the second compensation line 350 (the second compensation line 350 from the left side) corresponding to the second set to the Mth set is the same as the length of the second compensation line 350 in the first set. Namely, the overlapped areas of the touch electrodes 230 are the same. The length of the first compensation line 350 is smaller than the length of the second compensation line 350 corresponding to the first set; the length of the third compensation line 350 (the third compensation line 350 from the left side) corresponding to the second set to the Mth set is the same as the length of the third compensation line 350 in the first set. Namely, the overlapped areas of the touch electrodes 230 are the same. The length of the second compensation line 350 is smaller than the length of the third compensation line 350 corresponding to the first set; . . . ; the length of the Nth compensation line 350 (the Nth compensation line 350 from the left side) corresponding to the second set to the Mth set is the same as the length of the Nth compensation line 350 in the first set. Namely, the overlapped areas of the touch electrodes 230 are the same. The length of the N-1th compensation line 350 is smaller than the length of the Nth compensation line 350 corresponding to the first set. The overlapped areas of the compensation lines 350 in the same set with the touch electrodes 230 are different. However, for the compensation lines 350, the overlapped areas of the compensation lines 350 with the touch electrodes 230 are partially the same and partially different. Besides, in other embodiment of the present invention, the lengths of all the compensation lines can be identical. Namely, the overlapped areas of all the compensation lines with the touch electrodes are equal. For instance, only one compensation line corresponding to each set of touch electrodes. The compensation line is arranged corresponding to the last wire. The length of these compensation lines is equal to the length of the last compensation line in each set in this embodiment. Besides, in other embodiments of the present invention, the lengths of all the compensation lines can be completely different. Namely, the overlapped areas of all the compensation lines with the touch electrodes are different. For instance, there are only N compensation lines, and the arrangement order of the N compensation lines is the same as the arrangement order of the compensation lines in a set of the touch electrodes in the this embodiment.

In addition, in the present embodiment, the array substrate does not comprise the suspension lines in the first embodiment.

Significantly, each of the embodiments in the specification is described in a progressive manner, and each embodiment focuses on the differences from other embodiments, and the same or similar parts among the various embodiments can be referred to one another. For the embodiment of the device, it is basically similar with the embodiment of method, so the description is simpler, and the related parts can be referred to the description of the embodiment of method.

With the description of the foregoing embodiment, the present invention has advantages below:

Since two ends of each of the wires are electrically connected to one of the touch electrodes and the driving unit, respectively. Therefore, the arrangement of the wires is not the running through type. When the touch electrode acts as a touch, the RC loading is small so that the touch signal is less distorted in transmission and has better touch characteristics; besides, the compensation line overlaps at least one touch electrode, and the compensation line receives a second common voltage as the touch electrode receives the first common voltage, and the first common voltage is equal to the second common voltage. Accordingly, the second common voltage transmitted by the compensation line may enhance the first common voltage on the touch electrode which is overlapped therewith for improving the problem that the first common voltage uniformity of the touch electrodes is poor to further improve the display effect of the screen.

Above are embodiments of the present invention, which does not limit the scope of the present invention. Any equivalent amendments within the spirit and principles of the embodiment described above should be covered by the protected scope of the invention.

What is claimed is:

1. An array substrate, comprising:
a substrate;
a driving unit, being provided on the substrate and outputting a touch signal and a first common voltage;
a common electrode layer, being provided on the substrate, and the common electrode layer comprising a plurality of touch electrodes, which are separately arranged, and the plurality of touch electrodes receiving the touch signal and the first common voltage in time division;
a plurality of wires, being provided on the substrate and extending along a first direction, and two ends of each of the wires being electrically connected to one of the touch electrodes and the driving unit, respectively;
at least one compensation line, which is separately arranged from the wires, and the compensation line extending in a direction opposite to the first direction, and the compensation line being overlapped with at least one of the touch electrodes, and the compensation line receiving a second common voltage as the one of the touch electrodes receives the first common voltage, and the first common voltage being equal to the second common voltage.

2. The array substrate according to claim 1, wherein a number of the compensation lines is plural, and the compensation lines are separately arranged corresponding to the wires, respectively.

3. The array substrate according to claim 2, wherein the number of the compensation lines is the same as a number of the wires.

4. The array substrate according to claim 2, wherein overlapped areas of the compensation lines with the touch electrodes are partially the same and partially different, and a length of the compensation line is negatively correlated with a length of a corresponding wire, and one end of the compensation line correspondingly close to one end of the wire and the one end of the wire correspondingly close to the one end of the compensation line are located above or below the same touch electrode; or all of the overlapped areas of the compensation lines with the touch electrodes are equal; or all of the overlapped areas of the compensation lines with the touch electrodes are different.

5. The array substrate according to claim 2, wherein the compensation line is located on an extension line of a wire corresponding thereto.

6. The array substrate according to claim 1, wherein the array substrate further comprises at least one suspension line, and the suspension line extending from one end of the wire electrically connected to the touch electrode in the direction opposite to the first direction, and the suspension line is electrically connected to the wire, and the suspension line is insulated from the compensation line, and the suspension line is located between a corresponding wire and a corresponding compensation line, or the corresponding wire of the suspension line has no compensation line corresponding thereto.

7. The array substrate according to claim 1, further comprising a control switch, wherein a control end of the control switch receives a control voltage to control on and off thereof, and an input end of the control switch receives the second common voltage, and an output end of the control switch is electrically connected to all of the compensation lines.

8. The array substrate according to claim 1, wherein M sets of touch electrodes are formed on the substrate, and each set comprises N of the touch electrodes, and the N of the touch electrodes in each set are arranged in the first direction, and a number of the wires is M*N, and each of the wires is electrically connected to one of the touch electrodes, and the first direction is a direction from top to bottom or from bottom to top, and lengths of the wires electrically connected to the touch electrodes in the same set are arranged in a descending order or in an ascending order, wherein N, M≥2.

9. The array substrate according to claim 1, wherein a layer where the wires are located on the substrate is different from a layer where the touch electrode are on the substrate, and an insulation layer is provided between the wires and the touch electrodes, and the compensation lines and the wires are in the same layer on the substrate.

10. A self capacitance in cell touch display panel, comprising an array substrate, wherein the array substrate comprises:
a substrate;
a driving unit, being provided on the substrate and outputting a touch signal and a first common voltage;
a common electrode layer, being provided on the substrate, and the common electrode layer comprising a plurality of touch electrodes, which are separately arranged, and the plurality of touch electrodes receiving the touch signal and the first common voltage in time division;
a plurality of wires, being provided on the substrate and extending along a first direction, and two ends of each of the wires being electrically connected to one of the touch electrodes and the driving unit, respectively;
at least one compensation line, which is separately arranged from the wires, and the compensation line extending in a direction opposite to the first direction, and the compensation line being overlapped with at least one of the touch electrodes, and the compensation line receiving a second common voltage as the one of the touch electrodes receives the first common voltage, and the first common voltage being equal to the second common voltage.

11. The array substrate according to claim 10, wherein a number of the compensation lines is plural, and the compensation lines are separately arranged corresponding to the wires, respectively.

12. The array substrate according to claim 11, wherein the number of the compensation lines is the same as a number of the wires.

13. The array substrate according to claim 11, wherein overlapped areas of the compensation lines with the touch electrodes are partially the same and partially different, and a length of the compensation line is negatively correlated with a length of a corresponding wire, and one end of the compensation line correspondingly close to one end of the wire and the one end of the wire correspondingly close to the one end of the compensation line are located above or below the same touch electrode; or all of the overlapped areas of the compensation lines with the touch electrodes are equal; or all of the overlapped areas of the compensation lines with the touch electrodes are different.

14. The array substrate according to claim 11, wherein the compensation line is located on an extension line of a wire corresponding thereto.

15. The array substrate according to claim 10, wherein the array substrate further comprises at least one suspension line, and the suspension line extending from one end of the wire electrically connected to the touch electrode in the direction opposite to the first direction, and the suspension line is electrically connected to the wire, and the suspension line is insulated from the compensation line, and the suspension line is located between a corresponding wire and a corresponding compensation line, or the corresponding wire of the suspension line has no compensation line corresponding thereto.

16. The array substrate according to claim 10, further comprising a control switch, wherein a control end of the control switch receives a control voltage to control on and off thereof, and an input end of the control switch receives the second common voltage, and an output end of the control switch is electrically connected to all of the compensation lines.

17. The array substrate according to claim 10, wherein M sets of touch electrodes are formed on the substrate, and each set comprises N of the touch electrodes, and the N of the touch electrodes in each set are arranged in the first direction, and a number of the wires is M*N, and each of the wires is electrically connected to one of the touch electrodes, and the first direction is a direction from top to bottom or from bottom to top, and lengths of the wires electrically connected to the touch electrodes in the same set are arranged in a descending order or in an ascending order, wherein N, M≥2.

18. The array substrate according to claim 10, wherein a layer where the wires are located on the substrate is different from a layer where the touch electrode are on the substrate, and an insulation layer is provided between the wires and the touch electrodes, and the compensation lines and the wires are in the same layer on the substrate.
